(19) United States
(12) Patent Application Publication
(10) Pub. No.: US 2012/0069853 A1
(43) Pub. Date: Mar. 22, 2012

(54) METHOD, APPARATUS, AND SYSTEM FOR DATA ACQUISITION

(75) Inventors: Lihe Liu, Shenzhen (CN); Jie Lv, Shenzhen (CN)

(73) Assignee: Huawei Technologies Co., Ltd, Shenzhen (CN)

(21) Appl. No.: 13/308,153

(22) Filed: Nov. 30, 2011

Related U.S. Application Data
(63) Continuation of application No. PCT/CN2010/073447, filed on Jun. 2, 2010.

(30) Foreign Application Priority Data
Jul. 3, 2009 (CN) 200910108613.6

(51) Int. Cl. H04J 99/00

(52) U.S. Cl. 370/462

(57) ABSTRACT

An embodiment of the present disclosure provides a method for data acquisition. The method includes the following steps: transmitting a request message for acquiring line parameters to a central-office end access apparatus, and obtaining a time parameter T1 when the line parameter acquisition is started; receiving line parameter information reported by the central-office end access apparatus, and obtaining a time parameter T2 of a line; and comparing the time parameter T1 with the time parameter T2 of the line, and saving the received line parameter information if the time parameter T1 is larger than the time parameter T2 of the line. Embodiments of the present disclosure further provide an apparatus and a system for data acquisition.

### CROSS-REFERENCE TO RELATED APPLICATIONS

This application is a continuation of International Application No. PCT/CN2010/073447, filed on Jun. 2, 2010, which claims priority to Chinese Patent Application No. 200910108613.6 entitled “METHOD, APPARATUS, AND SYSTEM FOR DATA ACQUISITION” and filed with Chinese Patent Office on Jul. 3, 2009, both of which are incorporated herein in its entirety by reference.

### FIELD

The present disclosure relates to the communication field, and more particularly, to a method, an apparatus, and a system for data acquisition.

### BACKGROUND

The digital subscriber line (Digital Subscriber Line, DSL) technology is a kind of high-speed transmission technology that carries out data transmission through telephone twisted-pair lines, in which the performance of the DSL line is usually improved through dynamic spectrum management DSM (Dynamic Spectrum Management). In order to accomplish the DSM function of a DSL system, characteristics of a crosstalk (crosstalk) channel of the line must be known. The characteristics of the crosstalk channel of the line can be obtained by acquiring subscriber line parameters and making calculations on the parameters. For example, such parameters as a transmit power spectrum density Transmit PSD and a signal to noise ratio SNR of the subscriber line can be acquired by a data acquisition system, and the crosstalk channel of the subscriber line can be calculated according to a formula for crosstalk channel calculation.

However, acquisition of the subscriber line parameters shall not be performed in an arbitrary fashion. In the DSM technology, there is a requirement on the acquired line parameters, and in one process of line parameters acquisition, acquisition of the line parameters is performed in sequence, which has a severe influence on the calculation of the crosstalk channel.

During implementation of the present disclosure, at least the following problems of the prior art are found by the present inventor:

In the prior art, the line parameters are acquired in a periodical fashion; i.e., the line parameters are acquired sequentially at a certain time interval. In the process of sequentially acquiring the line parameters of the system, because the time required for the whole acquisition process is relatively long, changes in states of some lines may occur, and the parameters thus acquired cannot meet requirements of the DSM technology.

### SUMMARY

The present disclosure provides a method, an apparatus, and a system for data acquisition to solve the problem that line parameter acquisition in a digital subscriber line system cannot meet requirements of system maintenance.

The embodiments provided by the present disclosure are for illustration only.

A method for line parameter acquisition, including: transmitting a request message for acquiring line parameters to a central-office end access apparatus, and obtaining a time parameter T1 when the line parameter acquisition is started; receiving line parameter information reported by the central-office end access apparatus, and obtaining a time parameter T2 of a line; and comparing the time parameter T1 with the time parameter T2 of the line, and saving the received line parameter information if the time parameter T1 is larger than the time parameter T2 of the line.

An apparatus for line parameter acquisition include a processor in communication with a configuration module, a control module, and a determination module. The configuration module is configured to generate a request message, in which the request message carries line information and parameter information thereof to be acquired. The control module in communication with the processor is configured to transmit the request message generated by the configuration module to a central-office end access apparatus, record a time parameter T1 when the central-office end access apparatus starts acquiring line parameters, receive line parameter information reported by the central-office end access apparatus, and obtain a time parameter T2 of the line. The determination module in communication with the processor is configured to compare the time parameter T1 with the time parameter T2 of the line, and save the line parameter information reported by the central-office end access apparatus if T2 is smaller than T1 or re-perform the line parameter acquisition if T2 is no smaller than T1.

A system for line parameter acquisition, including a data acquisition apparatus and a central-office end access apparatus, in which: the data acquisition apparatus is configured to: generate a request message which carries line information on a line and parameter information thereof to be acquired, transmit the request message to the central-office end access apparatus, and record a time parameter T1 when the central-office end access apparatus starts acquiring line parameters; receive line parameter information reported by the central-office end access apparatus, and obtain a time parameter T2 of the line; compare the time parameter T1 with the obtained time parameter T2 of the line, and save the line parameter information reported by the central-office end access apparatus if T2 is smaller than T1 or re-perform the line parameter acquisition if T2 is no smaller than T1; and the central-office end access apparatus is configured to: after receiving the request message transmitted by the data acquisition apparatus, perform the parameter acquisition on the line according to information in the request message, and report the parameters acquired to the data acquisition apparatus.

According to the embodiments of the present disclosure, the problem that line parameter acquisition is inconsistent due to changes in line states during the line parameter acquisition can be avoided by transmitting a request message for acquiring line parameters to a central-office end access apparatus, and obtaining a time parameter T1 when the line parameter acquisition is started; receiving line parameter information reported by the central-office end access apparatus, and obtaining a time parameter T2 of the line; and comparing the time parameter T1 with the time parameter T2 of the line, and saving the received line parameter information if the time parameter T1 is larger than the time parameter T2 of the line. That is, in the DSL system, when it is needed to acquire the line parameters, just acquiring the time parameter of the line at the same time and comparing the time parameter with certain time information can avoid this problem. Therefore, the problem that the line parameter acquisition in the DSL system cannot meet requirements of system maintenance is solved.

### BRIEF DESCRIPTION OF THE DRAWINGS

FIG. 1 is a flowchart of a method according to an embodiment of the present disclosure;

FIG. 2 is a schematic diagram of parameter acquisition according to an embodiment of the present disclosure;

FIG. 3 is a schematic structural diagram of an apparatus according to an embodiment of the present disclosure; and

FIG. 4 is a schematic structural diagram of a system according to an embodiment of the present disclosure.

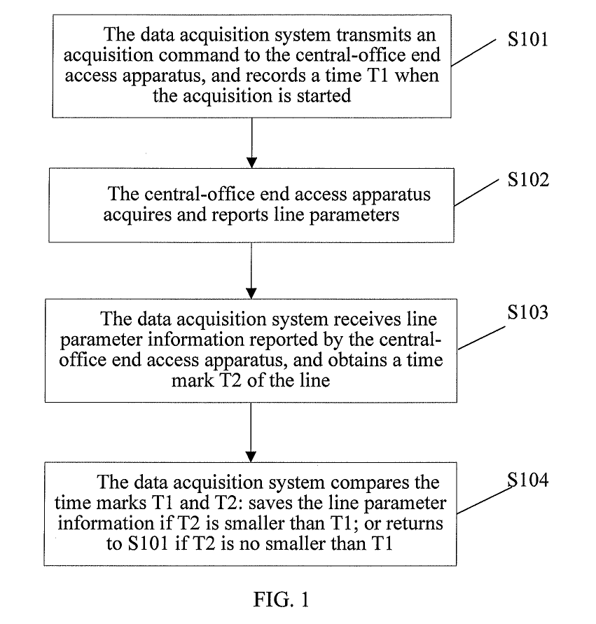

### DETAILED DESCRIPTION OF THE EMBODIMENTS

Hereinafter, embodiments of the present disclosure will be explained clearly and completely in conjunction with the attached drawings in the embodiments of the present disclosure. Obviously, the embodiments described are only parts but not all of embodiments of the present disclosure. Other embodiments that can be obtained by those of ordinary skill in the art based on these embodiments of the present disclosure without making any inventive efforts shall all fall in the protection scope of the present disclosure.

In the prior art, during the process of sequentially acquiring the line parameters of the system, because the acquisition time is relatively long, changes in states of some lines may occur, and the data thus acquired cannot meet the requirements of the DSM technology on the parameters.

For example, if a crosstalk channel [H₁₂ⁿ . . . H_{1K}ⁿ]^{T} of a line 1 is to be calculated according to the following formula using the acquired parameters, then a transmit power spectrum density Transmit PSD of the line and a signal to noise ratio (SNR) of the line need to be acquired and then the crosstalk channel of the line 1 is calculated using the Formula 1.

$$[ \begin{matrix}{TxPSD}_{2}^{n} , & … , & {TxPSD}_{K}^{n}\end{matrix} ] \cdot [ \begin{matrix}{H}_{12}^{n} \\ ⋮ \\ {H}_{1 K}^{n}\end{matrix} ] = \frac{{H}_{11}^{n} \cdot {TxPSD}_{1}^{n}}{{SNR}_{1}^{n}} - {σ}_{k}^{n} \qquad ( Formula 1 )$$

This needs data acquisition several times to form an equation set for solution.

$$[ \begin{matrix}{TxPSD}_{2}^{n} ( {t}_{1} ) , & … , & {TxPSD}_{K}^{n} ( {t}_{1} ) \\ ⋮ & ⋮ & ⋮ \\ {TxPSD}_{2}^{n} ( {t}_{L} ) , & … , & {TxPSD}_{2}^{n} ( {t}_{L} )\end{matrix} ] \cdot [ \begin{matrix}{H}_{12}^{n} \\ ⋮ \\ {H}_{1 K}^{n}\end{matrix} ] = [ \begin{matrix}\frac{{H}_{11}^{n} \cdot {TxPSD}_{1}^{n} ( {t}_{1} )}{{SNR}_{1}^{n} ( {t}_{1} )} - {σ}_{1}^{n} \\ ⋮ \\ \frac{{H}_{11}^{n} \cdot {TxPSD}_{1}^{n} ( {t}_{L} )}{{SNR}_{1}^{n} ( {t}_{L} )} - {σ}_{1}^{n}\end{matrix} ]$$

For each parameter acquisition, parameters needed to be acquired are as shown in the Table 1:

TABLE 1

| Subscriber 1 | | | Subscriber k | | | Subscriber K | |
|---|---|---|---|---|---|---|---|
| Transmit | | | Transmit | | | Transmit | |
| PSD | SNR | . . . | PSD | SNR | . . . | PSD | SNR |
| TxPSD₁ⁿ (t) | SNR₁ⁿ (t) | | TxPSDₖⁿ (t) | SNRₖⁿ (t) | | TxPSD_{K}ⁿ (t) | SNR_{K}ⁿ (t) |
| Timepoint(1) | Timepoint(2) | | Timepoint(l) | Timepoint(l + 1) | | Timepoint(L − 1) | Timepoint(L) |

In one data acquisition process, the acquisition is performed in sequence for the subscribers. Acquisition of the SNR₁ⁿ(t) at the Timepoint(2) corresponds to that of the TxPSDₖⁿ(t), kεK at the Timepoint(2). However, when the TxPSDₖⁿ(t), kεK of the subscriber k is acquired at the Timepoint(l), and if the TxPSDₖⁿ(t), kεK at the Timepoint(2) is significantly different from that at the Timepoint(l), the SNR₁ⁿ(t) will mismatch with the TxPSDₖⁿ(t), which has an adverse influence on the calculation of a crosstalk channel.

In view of the problem of the prior art, an embodiment of the present disclosure provides a method for line parameter acquisition, which specifically includes the following steps:

S101: Transmit a request message for acquiring line parameters to a central-office end access apparatus and obtain a time parameter T1 when the acquisition of the line parameters is started. In one embodiment, a central-office end access apparatus is a multi-service access module. The multi-service access may include the following service.
Broadband access service
   Asymmetric digital subscriber line 2 plus (ADSL2+)
   Single-pair high-speed digital subscriber line (SHDSL)
   Very high-speed digital subscriber line 2 (VDSL2)
Voice service
   Telephone service, fax service, narrowband modem service.
      In some embodiments, the central-office end access apparatus have its storage memory accessible to a processor and a DSL chipset.

S102: Receive line parameter information reported by the central-office end access apparatus and obtain a time parameter T2 of a line.

S103: Compare the time parameter T1 with the time parameter T2, and save the received line parameter information if the time parameter T1 is larger than the time parameter T2.

In this embodiment of the present disclosure, the line parameters are acquired, and the time parameter of a specified line is acquired. Then, the time parameter of the line is compared with the time when the acquisition of the line parameters is started. If the time parameter of the line meets a certain condition, it means that the acquisition of the line parameters meets the requirement of the present disclosure and then the acquired line parameters are saved. Hereinafter, the method of this embodiment of the present disclosure will be described in detail.

Step 1: A data acquisition system generates a request message which carries line information and parameter information thereof to be acquired, transmits the request message to a central-office end access apparatus, and records a time parameter T1 when the central-office end access apparatus starts acquiring line parameters.

Preferably, the request message generated by the data acquisition system may be of the SNMP (Simple Network Management Protocol, simple network management protocol) format. A database operating system packages subscriber line information for this acquisition and line parameter information to be acquired this time into an SNMP message to generate the request message.

Generally, the data acquisition system is connected to the central-office end access apparatus through a Q interface (see the definition in the standard YD/T761-1995). The data acquisition system transmits the request message of the SNMP format to the central-office end access apparatus through the Q interface and records a time when the request message is transmitted. Preferably, the aforesaid time when the request message is transmitted is recorded as T1 to represent the time when this parameter acquisition is started.

Step 2: After receiving the request message transmitted by the data acquisition system, the central-office end access apparatus acquires parameters of the line according to the information in the request message, and reports the acquired parameters to the data acquisition system.

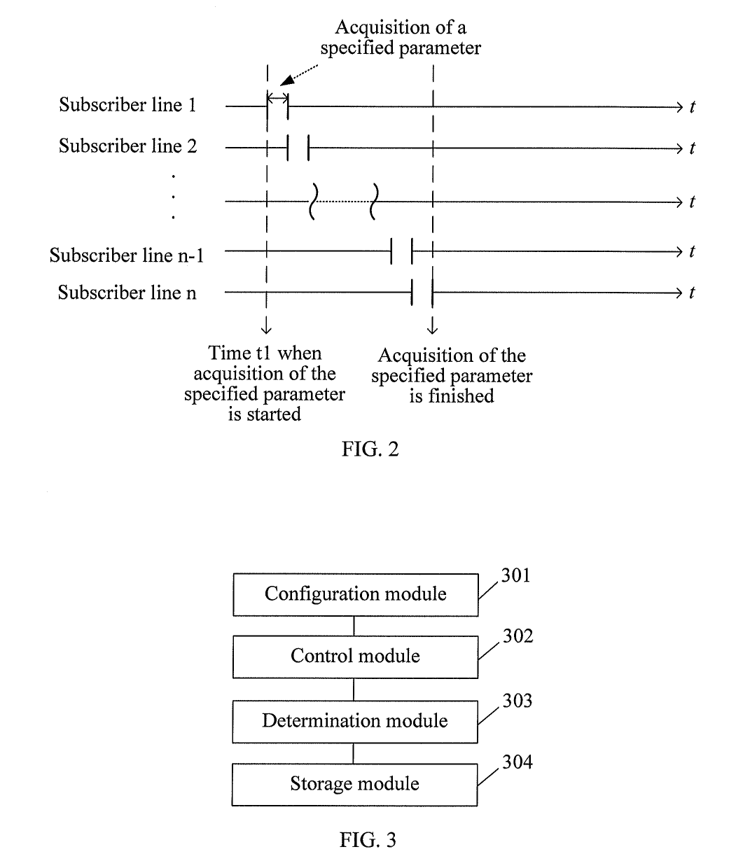

After receiving the request message, the central-office end access apparatus acquires the specified parameters of the line specified in the message according to contents of the request message. Taking line parameters required for calculating the a crosstalk channel in a DSL system as an example, line parameter information that need to be acquired at least includes information of a transmit power spectrum density and a signal to noise ratio. Of course, contents of the line parameter information are not limited in this embodiment, and line parameter information specified in the DSL standard may be acquired depending on requirements of practical applications. With reference to FIG. 2 for the detailed process, for example, this parameter acquisition is performed on n subscriber lines. The central-office end access apparatus starts parameter acquisition from the subscriber line 1 and performs the acquisition sequentially until the parameter acquisition on the subscriber line n is finished, thus completing this data acquisition. The central-office end access apparatus reports the acquired line parameter information to the data acquisition system through the Q interface. Preferably, when reporting the line parameter information to the data acquisition system, the central-office end access apparatus may report the line parameter information to the data acquisition system at a time in a package form.

Step 3: The data acquisition system receives the line parameter information reported by the central-office end access apparatus, and obtains a time parameter T2 of the line.

Preferably, after receiving the line parameter information reported by the central-office end access apparatus, the data acquisition system may save the parameter information into a buffer unit. The buffer unit may be a storage unit in the data acquisition system, or may be a part of storage units in a database independent of the data acquisition system.

In which, the time parameter T2 of the line is obtained. Preferably, the time parameter T2 of the line may be a time STAMP-OLR parameter when the line is reconfigured online or a time parameter when an operation state of the subscriber line changes, or may be a larger (i.e., the latest in terms of time) one of the STAMP-OLR parameter and the time parameter when the operation state of the subscriber line changes.

Further, the time parameter when the operation state of the subscriber line changes is a time parameter corresponding to the time parameter when the operation state of the subscriber line experiences the latest change with reference to the time parameter T1 when the parameter acquisition is started. The change in the operation state of the subscriber line includes deactivation, activation, power mode switching and so on. When an operation state of a certain subscriber line changes, the central-office end access apparatus obtains the type of the change (deactivation, activation or power mode switching) in the operation state of the subscriber line and the time when the operation state of the subscriber line changes. The STAMP-OLR parameter (with reference to the definition in the standard G.997.1) refers to the time parameter when the online reconfiguration occurs, for example, a time stamp when the latest online reconfiguration occurs. The central-office end access apparatus obtains the STAMP-OLR parameter by performing acquisition on the specified lines respectively.

Step 4: The data acquisition system compares the time parameter T1 when the acquisition of the line parameters is started with the obtained time parameter T2 of the line, and saves the line parameter information reported by the central-office end access apparatus if T2 is smaller than T1 or returns to the step 1 to re-perform the line parameter acquisition if T2 is no smaller than T1.

The data acquisition system obtains the time parameter T2 (n) of the specified line n, and determines through comparison whether the time parameter (time parameter) T2 (n) of the specified line n is smaller than the time parameter T1 when the acquisition of the line parameters is started. If, after comparisons have been made on all the specified lines, all the time parameters T2 of the specified lines are smaller than the time parameter T1 when the acquisition of the line parameters is started, it can be determined that the acquired line parameters meet the requirements and the data acquisition system saves the line parameters reported by the central-office end access apparatus. If, during the comparison, the time parameter of a certain specified line is not smaller than (i.e., larger than or equal to) the time parameter T1 when the acquisition is started, it can be determined that the acquired line parameters cannot meet the requirements, so the data acquisition system terminates the determination and returns to the step 1 to re-perform the acquisition.

Further, the step 3 and the step 4 that are described above may also be as described hereinbelow.

Step 3: The data acquisition system receives the line parameter information reported by the central-office end access apparatus, records a time T3 when the line parameter acquisition by the central-office end access apparatus is finished, and obtains the time parameter T2 of the line. Preferably, T3 represents the time when the reported line parameter information is received.

Step 4: The data acquisition system compares the time parameter T1 when it transmits the request message with the obtained time parameter T2 of the line, and saves the line parameter information reported by the central-office end access apparatus if T2 is smaller than T1 or T2 is larger than T3, or returns to the step 1 to re-perform the line parameter acquisition if T2 is no smaller than T1 and no larger than T3.

Further, the process of obtaining the time parameter T2 of the line in the step 3 specifically includes the following steps:

Step 3a: The data acquisition system transmits a command of acquiring a time parameter when a line operation state changes to the central-office end access apparatus, and obtains the time parameter when the line operation state changes transmitted by the central-office end access apparatus.

When an operation state of a certain subscriber line changes, the central-office end access apparatus transmits the time parameter when the line operation state changes to the data acquisition system in real time according to the command from the data acquisition system. The message includes the type of the change (deactivation, activation or power modes) in the operation state of the subscriber line and/or the time when the operation state of the subscriber line changes. The data acquisition system records at least the time parameter when the latest change in the operation state occurs (with reference to the time parameter T1 when the parameter acquisition is started, which also applies to the following description). Preferably, the data acquisition system may record the correspondence relationship between the type of the latest change in the line operation state and the time parameter when the latest change in the operation state occurs so that the data acquisition system can better know the specific type of the change in the operation state. The type of the change in the operation state described above may also be replaced by other information, for example, information that indicates a change in the operation state.

Step 3b: The data acquisition system transmits a command of acquiring the STAMP-OLR parameter to the central-office end access apparatus, and obtains the STAMP-OLR parameter transmitted by the central-office end access apparatus.

The STAMP-OLR parameter (with reference to the definition in the standard G.997.1) refers to the time parameter when the latest online reconfiguration occurs (with reference to the time parameter T1 when the parameter acquisition is started, which also applies to the following description), for example, a time stamp when the latest online reconfiguration occurs. The STAMP-OLR parameter is acquired from specified lines respectively by a management entity of the central-office end access apparatus.

Step 3c: The data acquisition system compares the obtained time parameter when the line operation state changes with the STAMP-OLR parameter, and determines the larger one (i.e., the later one in terms of time) as T2.

Further, the aforesaid step 1 may further include the following steps. The data acquisition system transmits a command of acquiring the time parameter when the line operation state changes. When an operation state of a certain subscriber line changes, the central-office end access apparatus transmits a response message to the data acquisition system in response to the aforesaid command. The response message includes the type of the change (activation or power modes) in the operation state of the subscriber line and the time when the operation state of the subscriber line changes. After receiving the message, the data acquisition system transmits a command of terminating the line parameter acquisition to the central-office end access apparatus through the Q interface, and returns to the step 1; if the data acquisition system does not receive the response message reported by the central-office end access apparatus, then the step 2 is executed.

An embodiment of the present disclosure further provides an apparatus for line parameter acquisition. As shown in FIG. 3, the apparatus includes a configuration module 301, a control module 302, and a determination module 303.

The configuration module 301 is configured to generate a request message, which carries line information and parameter information thereof to be acquired.

The control module 302 is configured to transmit the request message generated by the configuration module 301 to a central-office end access apparatus, and record a time parameter T1 when the central-office end access apparatus starts the acquisition of the line parameters. The request message is used to make the central-office end access apparatus perform the line parameter acquisition according to the information in the request message. The central-office end access apparatus reports the acquired parameters. The central-office end access apparatus reports the acquired line parameter information to the data acquisition system through a Q interface. Preferably, when reporting the line parameter information to the data acquisition system, the central-office end access apparatus may report the line parameter information to the data acquisition system at a time in a package form. In which, the process of the line parameter acquisition is just the same as what described in the aforesaid method embodiments.

The control module 302 is configured to receive the line parameter information reported by the central-office end access apparatus, and obtain a time parameter T2 of the line.

The determination module 303 is configured to compare the time parameter T1 when the acquisition of the line parameters is started and the obtained time parameter T2 of the line, and save the line parameter information reported by the central-office end access apparatus if T2 is smaller than T1 or re-perform the line parameter acquisition if T2 is no smaller than T1.

Preferably, after receiving the line parameter information reported by the central-office end access apparatus, the control module 302 may save the parameter information into a buffer module 304. The buffer module 304 may be a storage module in the data acquisition system, or may be a part of storage modules in a database independent of the apparatus for the line parameter acquisition.

In which, the time parameter T2 of the line is obtained. Preferably, the time parameter T2 of the line may be a time STAMP-OLR parameter when the line is reconfigured online or a time parameter when an operation (operation) state of the subscriber line changes, and may also be the larger one (the later one in terms of time) of the STAMP-OLR parameter and the time parameter when the operation state of the subscriber line changes.

Further, the time parameter when the operation state of the subscriber line changes is a time parameter corresponding to the time parameter when the operation state of the subscriber line experiences the latest change with reference to the time parameter T1 when the parameter acquisition is started. The change in the operation state of the subscriber line includes deactivation, activation, power mode switching and so on. When an operation state of a certain subscriber line changes, the central-office end access apparatus obtains the type of the change (deactivation, activation or power mode switching) in the operation state of the subscriber line and the time when the operation state of the subscriber line changes. The STAMP-OLR parameter (with reference to the definition in the standard G.997.1) refers to the time parameter when the online reconfiguration occurs, for example, a time stamp when the latest online reconfiguration occurs. The central-office end access apparatus obtains the STAMP-OLR parameter by performing acquisition on the specified lines respectively.

Preferably, the request message generated by the configuration module 301 may be of the SNMP (Simple Network Management Protocol, simple network management protocol) format. Subscriber line information for this acquisition and line parameter information to be acquired this time are packaged into an SNMP message to generate the request message.

Generally, the control module 302 is connected to the central-office end access apparatus through a Q interface (see the definition in the standard YD/T761-1995). The data acquisition system transmits the request message of the SNMP format to the central-office end access apparatus through the Q interface and records a time when the request message is transmitted. Preferably, the aforesaid time when the request message is transmitted is recorded as T1 to represent the time when this parameter acquisition is started.

In which, the time parameter T2 of the line is obtained. Preferably, the time parameter T2 of the line may be a time STAMP-OLR parameter when the line is reconfigured online or a time parameter when an operation state of the subscriber line changes, and may also be the larger one (the later one in terms of time) of the STAMP-OLR parameter and the time parameter when the operation state of the subscriber line changes.

Further, the time parameter when an operation state of the subscriber line changes is a time parameter corresponding to the time parameter when the operation state of the subscriber line experiences the latest change with reference to the time parameter T1 when the parameter acquisition is started. The change in the operation state of the subscriber line includes deactivation, activation, power mode switching and so on. When an operation state of a certain subscriber line changes, the central-office end access apparatus obtains the type of the change (deactivation, activation or power mode switching) in the operation state of the subscriber line and the time when the operation state of the subscriber line changes. The STAMP-OLR parameter (with reference to the definition in the standard G.997.1) refers to the time parameter when the online reconfiguration occurs, for example, a time stamp when the latest online reconfiguration occurs. The central-office end access apparatus obtains the STAMP-OLR parameter by performing acquisition on the specified lines respectively.

Further, the control module 302 is further configured to receive the line parameter information reported by the central-office end access apparatus, and record a time T3 when the line parameter acquisition by the central-office end access apparatus is finished. Preferably, T3 represents the time when the reported line parameter information is received.

The determination module 303 is further configured to compare the time parameter T1, the time parameter T2 of the line, and the time T3 when the line parameter acquisition is finished, and save the line parameter information reported by the central-office end access apparatus if T2 is smaller than T1 or T2 is larger than T3 or re-perform the line parameter acquisition if T2 is no smaller than T1 and no larger than T3.

The process of obtaining the time parameter T2 of the line by the control module 302 specifically includes the following steps:

Step 1: The control module transmits a command of acquiring the time parameter when the line operation state changes to the central-office end access apparatus, and obtains the time parameter when the line operation state changes transmitted by the central-office end access apparatus.

When an operation state of a certain subscriber line changes, the central-office end access apparatus transmits the time parameter when the line operation state changes to the control module 302 in real time according to the command from the data acquisition system. The message includes the type of the change (deactivation, activation or power modes) in the operation state of the subscriber line and/or the time when the operation state of the subscriber line changes. The control module 302 can control a buffer to record at least the time parameter when the latest change in the operation state occurs (with reference to the time parameter T1 when the parameter acquisition is started, which also applies to the following description). Preferably, the control module 302 may control the buffer to record the correspondence relationship between the type of the latest change in the line operation state and the time parameter when the latest change in the operation state occurs so that the data acquisition system can better know the specific type of the change in the operation state. The type of the change in the operation state described above may also be replaced by other information, for example, information that indicates a change in the operation state.

Step 2: the control module 302 transmits a command of acquiring the STAMP-OLR parameter to the central-office end access apparatus, and obtains the STAMP-OLR parameter transmitted by the central-office end access apparatus.

The STAMP-OLR parameter (with reference to the definition in the standard G.997.1) refers to the time parameter (with reference to the time parameter T1 when the parameter acquisition is started, which also applies to the following description) when the latest online reconfiguration occurs, for example, a time stamp when the latest online reconfiguration occurs. The STAMP-OLR parameter is acquired from specified lines respectively by a management entity of the central-office end access apparatus.

Step 3: The control module 302 compares the obtained time parameter when the line operation state changes with the STAMP-OLR parameter, and determines the larger one (i.e., the later one in terms of time) as T2.

The apparatus further includes a storage module 304 configured to store the line parameter information reported by the central-office end access apparatus.

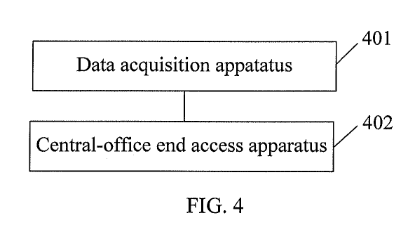

An embodiment of the present disclosure further provides a system for line parameter acquisition. A schematic structural diagram of the system is shown in FIG. 4. The system includes a data acquisition apparatus 401 and a central-office end access apparatus 402.

The data acquisition apparatus 401 is configured to: generate a request message which carries line information and parameter information thereof to be acquired, transmit the request message to the central-office end access apparatus 402, and record the time parameter T1 when the central-office end access apparatus 402 starts to acquire the line parameters; the data acquisition apparatus 401 receive the line parameter information reported by the central-office end access apparatus 402, and obtain the time parameter T2 of the line; and compare the time parameter T1 when it transmits the request message with the obtained time parameter T2 of the line, and save the line parameter information reported by the central-office end access apparatus 402 if T2 is smaller than T1 or re-perform the line parameter acquisition if T2 is no smaller than T1.

The central-office end access apparatus 402 is configured to, after receiving the request message transmitted by the data acquisition apparatus 401, perform the parameter acquisition on the line according to information in the request message, and report the acquired parameters to the data acquisition apparatus 401.

Preferably, the request message may be of the SNMP (Simple Network Management Protocol) format. Subscriber line information for this acquisition and line parameter information to be acquired this time are packaged into an SNMP message to generate the request message.

The process of obtaining the time parameter T2 of the line by the data acquisition apparatus 401 specifically includes the following steps:

a: The data acquisition apparatus 401 transmits a command of acquiring the time parameter when the line operation state changes to the central-office end access apparatus 402, and obtains the time parameter when the line operation state changes transmitted by the central-office end access apparatus 402.

When an operation state of a certain subscriber line changes, the central-office end access apparatus 402 transmits the time parameter when the line operation state changes to the data acquisition apparatus 401 in real time according to the command from the data acquisition apparatus 401. The message includes the type of the change (activation or power mode switching) in the operation state of the subscriber line and/or the time when the operation state of the subscriber line changes. The data acquisition apparatus 401 records at least the time parameter when the latest change in the operation state occurs (with reference to the time parameter T1 when the parameter acquisition is started, which also applies to the following description). Preferably, the data acquisition apparatus 401 may record the correspondence relationship between the type of the latest change in the line operation state and the time parameter when the latest change in the operation state occurs so that the data acquisition apparatus 401 can better know the specific type of the change in the operation state. The type of the change in the operation state described above may also be replaced by other information, for example, information that indicates the change in the operation state.

b: The data acquisition apparatus 401 transmits a command of acquiring the STAMP-OLR parameter to the central-office end access apparatus 402, and obtains the STAMP-OLR parameter transmitted by the central-office end access apparatus 402.

The STAMP-OLR parameter (with reference to the definition in the standard G997.1) refers to the time parameter when the latest online reconfiguration occurs (with reference to the time parameter T1 when the parameter acquisition is started, which also applies to the following description), for example, a time stamp when the latest online reconfiguration occurs. The STAMP-OLR parameter is acquired from specified lines respectively by a management entity of the central-office end access apparatus 402.

c: The data acquisition apparatus 401 compares the obtained time parameter when the line operation state changes with the STAMP-OLR parameter, and determines the larger one (i.e., the later one in terms of time) as T2.

Further, the data acquisition apparatus 401 is further configured to receive the line parameter information reported by the central-office end access apparatus 402, and record the time T3 when the line parameter acquisition by the central-office end access apparatus is finished. Preferably, T3 represents the time when the reported line parameter information is received.

The data acquisition apparatus 401 is further configured to compare the time parameter T1, the time parameter T2 of the line and the time T3 when the line parameter acquisition is finished, and save the line parameter information reported by the central-office end access apparatus if T2 is smaller than T1 or T2 is larger than T3 or re-perform the line parameter acquisition if T2 is no smaller than T1 and no larger than T3.

As will be appreciated by those of ordinary skill in the art, all or a part of the process in the method of the aforesaid embodiment can be implemented by a relevant hardware, software or a combination of hardware and software system under instruction of a computer program. The hardware or hardware system may include a processor configured to implement the disclosed method and system. The program may be stored in a computer readable storage medium accessible to the processor, and when being executed, may include the process of the each method of the embodiment described above. The storage medium may be a magnetic disk, a compact disk, a read-only memory (Read-Only Memory, ROM) or a random access memory (Random Access Memory, RAM).

The method, the apparatus and the system for DSL time synchronization provided by the embodiments of the present disclosure have been described in detail above. Although the principles and implementations of the present disclosure have been described with reference to specific embodiments herein, the above description of the embodiments is only intended to facilitate understanding of the present disclosure. Meanwhile, modifications in terms of the implementations and the application scope may be made by those of ordinary skill in the art based on the above description. Accordingly, the content of the specification shall not be considered as limitations to the present disclosure.

What is claimed is:

1. A method for line parameter acquisition, comprising:
transmitting a request message for acquiring line parameters to a central-office end access apparatus, and obtaining a time parameter T1 indicating when the line parameter acquisition is started;
receiving line parameter information reported by the central-office end access apparatus, and obtaining a time parameter T2 of a line; and
comparing the time parameter T1 with the time parameter T2 of the line, and saving the received line parameter information if the time parameter T1 is larger than the time parameter T2 of the line.

2. The method as claimed in claim 1, wherein the time parameter T2 of the line is a time parameter when an operation state of a subscriber line changes, or is a larger one of a time parameter when the line is reconfigured online and the time parameter when the operation state of the subscriber line changes.

3. The method as claimed in claim 2, wherein the time parameter when the operation state of the subscriber line changes is corresponding to the time parameter when the operation state of the subscriber line experiences the latest change with reference to the time parameter T1.

4. The method as claimed in claim 1, wherein after transmitting the request message for acquiring the line parameters to the central-office end access apparatus and before receiving the line parameter information reported by the central-office end access apparatus, the method further comprises:
transmitting a command of acquiring the time parameter when the operation state of the line changes, and re-performing the line parameter acquisition if a response message reported by the central-office end access apparatus is received; receiving the line parameter information reported by the central-office end access apparatus if no response message reported by the central-office end access apparatus is received.

5. The method as claimed in claim 3, wherein after transmitting the request message for acquiring the line parameters to the central-office end access apparatus and before receiving the line parameter information reported by the central-office end access apparatus, the method further comprises:
transmitting a command of acquiring the time parameter when the operation state of the line changes, and re-performing the line parameter acquisition if a response message reported by the central-office end access apparatus is received; receiving the line parameter information reported by the central-office end access apparatus if no response message reported by the central-office end access apparatus is received.

6. The method as claimed in claim 1, further comprising:
recording a time T3 when the central-office end access apparatus reports the line parameters, and saving the line parameter information reported by the central-office end access apparatus if T2 is larger than T3.

7. The method as claimed in claim 2, further comprising:
recording a time T3 when the central-office end access apparatus reports the line parameters, and saving the line parameter information reported by the central-office end access apparatus if T2 is larger than T3.

8. An apparatus for line parameter acquisition, comprising:
a processor,
a configuration module in communication with the processor, configured to generate a request message, the request message carries line information and parameter information thereof to be acquired;
a control module in communication with the processor, configured to transmit the request message generated by the configuration module to a central-office end access apparatus, record a time parameter T1 when the central-office end access apparatus starts acquiring line parameters, receive line parameter information reported by the central-office end access apparatus, and obtain a time parameter T2 of the line; and
a determination module in communication with the processor, configured to compare the time parameter T1 with the time parameter T2 of the line, and save the line parameter information if T2 is smaller than T1 or re-perform the line parameter acquisition if T2 is no smaller than T1.

9. The apparatus as claimed in claim 8, wherein:
the control module is further configured to receive the line parameter information reported by the central-office end access apparatus and record a time T3 when the line parameter acquisition by the central-office end access apparatus is finished; and
the determination module is further configured to compare the time parameter T1, the time parameter T2 of the line, and the time T3, and save the line parameter information if T2 is smaller than T1 or T2 is larger than T3, or re-perform the line parameter acquisition if T2 is no smaller than T1 and no larger than T3.

10. The apparatus as claimed in claim 8, further comprising:
a storage module, configured to store the line parameter information reported by the central-office end access apparatus.

11. A system for line parameter acquisition, comprising a data acquisition apparatus and a central-office end access apparatus, wherein:
the data acquisition apparatus is configured to: generate a request message which carries line information and parameter information thereof to be acquired, transmit the request message to the central-office end access apparatus, and record a time parameter T1 when the central-office end access apparatus starts acquiring line parameters; receive line parameter information reported by the central-office end access apparatus, and obtain a time parameter T2 of the line; and compare the time parameter T1 when it transmits the request message with the obtained time parameter T2 of the line, and save the line parameter information reported by the central-office end access apparatus if T2 is smaller than T1 or re-perform the line parameter acquisition if T2 is no smaller than T1; and
the central-office end access apparatus is configured to: after receiving the request message transmitted by the data acquisition apparatus, perform the parameter acquisition on the line according to information in the request message, and report the parameters acquired to the data acquisition apparatus.

12. The system as claimed in claim 11, wherein:
the data acquisition apparatus is further configured to: receive the line parameter information reported by the central-office end access apparatus, and record a time T3 when the line parameter acquisition by the central-office end access apparatus is finished, compare the time parameter T1, the time parameter T2 of the line, and the time T3 when the line parameter acquisition is finished, and save the line parameter information if T2 is smaller than T1 or T2 is larger than T3 or re-perform the line parameter acquisition if T2 is no smaller than T1 and no larger than T3.
